(19) United States
(12) Patent Application Publication
(10) Pub. No.: US 2012/0086664 A1
(43) Pub. Date: Apr. 12, 2012

(54) MULTIFUNCTIONAL WRITING APPARATUS WITH CAPACITIVE TOUCH SCREEN STYLUS

(76) Inventor: Gerald Leto, San Jose, CA (US)

(21) Appl. No.: 13/060,645

(22) PCT Filed: Jun. 29, 2010
(86) PCT No.: PCT/US2010/040361

§ 371 Date: Feb. 24, 2011

Related U.S. Application Data
(60) Provisional application No. 61/269,752, filed on Jun. 29, 2009.

(51) Int. Cl. G06F 3/044; G06F 3/041; G06F 3/033

(52) U.S. Cl. 345/174; 345/179; 345/173

(57) ABSTRACT

A multifunctional writing apparatus includes a writing device and a stylus operable to control a capacitive touch screen display device. The multifunctional apparatus includes an electrically conducting body having a first end and a second end. The first end includes a writing device such as a pen or pencil which allows a user to write on a paper or another type of media. The second end of the body comprises an electrically conductive portion which, when in contact with a capacitive based touch screen display device, allows a user to make a capacitive coupling and operate the touch screen display device.

### CROSS-REFERENCE TO RELATED APPLICATIONS

The present application is a 371 of PCT International Patent Application No. PCT/US2010/040361, filed Jun. 29, 2010 and claims the benefit of U.S. Provisional Patent Application No. 61/269,752, filed Jun. 29, 2009.

### BACKGROUND OF THE INVENTION

The present invention relates generally to writing and stylet apparatuses and in particular to writing and stylet apparatuses that include in combination a pen and a capacitive touch screen stylus.

Various pen devices are known for use in writing on paper. Ball point pens and mechanical pencils are longstanding examples.

Stylus devices have also been used in electronics devices that include touch screen displays comprising a touch sensitive transparent panel covering the screen. For example, a stylet is described in U.S. Pat. No. 5,654,529.

Additionally, stylets have been combined with ball point pens. For example, U.S. Pat. No. 6,450,721 and U.S. Patent Application Publication Nos.: US 2006/0083579 A1 and US 2006/0143874 A1 discloses combination devices, which include a ball point pen and a stylus. In these devices, a stylus tip is located on one end of a generally cylindrical combination device, and a ball point pen is located on the opposite end of the device. U.S. Pat. No. 6,412,998 also discloses a combination ball point pen and stylus while U.S. Pat. No. 6,749,354 discloses combination device that includes pencil lead feeder and a ball point pen which ride on a rotary cam which allows one or the other of the ball point pen or pencil lead feeder to drop down into a writing position when the pen housing is twisted. A stylus tip is disposed on an opposing end of the pen under the pen cap.

Such combinations, however, have shortcomings. They do not enable use with multi-touch capacitive touch screen devices and have limited utility with electronic devices having resistive touch screen displays. Such devices are not useful for devices enabled with gesture capabilities such as, for example, the Apple iPhone®manufactured by Apple Computer, Cupertino, Calif. Gesture capable devices allow for multiple point touch software applications and interaction.

Accordingly, there is a need for an improved writing instrument having multiple functions including the ability to write and/or be used as a capacitive touch screen stylus.

### SUMMARY OF THE INVENTION

A multi-functional pen input device includes a conventional writing device and a stylus for use with capacitive touch screen display devices. The writing device may be a conventional type of writing device for use on, for example, a paper medium or another surface. In one embodiment of the present invention, the writing device is a ball point pen, felt tip pen and/or a pencil lead feeder and is carried in a single housing which includes a cap portion and a barrel portion. The stylus portion includes a conductive tip portion. In one embodiment, the conductive portion of the stylus tip is made of a rubber, foam, or leather. Unlike known pen input devices, the multi-function pen input device can be used with electronic devices that include resistive, capacitive or other type of touch screen devices, including multi-touch capacitive touch screen electronic devices.

In another embodiment, the multifunction pen input device further includes an angled tip, providing the user of the device a more accurate view of the screen and permitting more accurate use. The tip is soft and conductive for specific interaction with capacitive touch screens that closely resemble the use of the human finger. The soft tip may be used with the touch screen without scratching or otherwise causing damage to the screen.

In another embodiment, there is at least one area of the cap which is constructed of either a conductive metal or conductive plastic, with a resistance of less than 1000 Ohms/cm²—made of a soft conductive substrate, allowing interaction of the device for use with a capacitive touch screen.

In another embodiment, a multi-functional writing apparatus includes a body having a cap portion and a barrel portion rotatable relative to the cap portion. The apparatus includes a cam arrangement or another actuation means for selectively and alternatively extending the writing device and/or a stylus into place for use. The writing device may be, for example, a ball point pen, felt pen, or pencil lead feeder. This actuation and cam action may be afforded, for example, by a twist of the cap portion with respect to the barrel portion.

In another embodiment, the cap portion, can be used as a stylus. In another embodiment, the cap may be removed from the device revealing a conductive surface allowing the user to take advantage of the gesturing capabilities of a multi-touch touch screen device, similar to how the multi-touch capacitive screen devices were intended to be used. For example, both the cap conductive tip and the pen body conductive tip may be used by a user to zoom in and out of web pages or other documents being viewed, allowing the user to avoid the need to physically touch the screen in order to do so.

In another embodiment, a multi-function writing apparatus or pen input device comprises a pen input device for use on a paper medium. The pen input device may be but is not limited to a ball point pen, felt tip pen, and/or a pencil lead feeder, and a passive stylus. The pen input device is carried in a single housing or body. In another embodiment, the writing apparatus includes a plurality or multiple housings such as a cap and a barrel. Unlike known pen input devices, the multi-function pen input device, in accordance with the described embodiments of the present invention, can be used with all touch screen enabling technologies, including but not restricted to resistive, surface acoustic wave, capacitive, multi-touch capacitive and projected capacitance touch screen capable electronic devices.

The multi-function pen input devices may comprise a conventional paper media input device, such as a pen or pencil, and one or more passive input devices comprised of a soft, electrically conductive tip suitable for interaction with a touch screen device, and an electrically conductive member, such as the pen body, an internal conductive element, or an electrically conductive outer layer or coating. The multi-function pen input device is fabricated in such a manner that the user may employ either the conventional paper media writing input device or the passive touch screen input device as desired. The device is further fabricated in such a manner that the soft electrically conductive tip is in electrically conductive or capacitively coupled connection with the electrically conductive pen body, internal element, outer layer or coating. The multi-function pen input device may have sufficient capacitance with respect to a distant ground that the pen input device is detectable by a capacitive touch screen device when the electrically conductive tip is brought near to the touch screen or is touched to the touch screen.

Furthermore, the multi-function pen input device may afford electrically conductive connection to an auxiliary conductive element, such as the human body or an electrically conductive or capacitive glove, wherein the electrical connection is achieved between the pen body and the auxiliary conductive element.

In another embodiment, a multi-function pen input device comprises a conventional pen input device, such as a ball point or felt tip pen, or a pencil lead feeder for writing on paper media, and a passive touch screen input device for interaction with touch screen electronic devices. The passive touch screen input device is comprised of a soft, electrically conductive tip, suitable for interaction with the touch screen, an electrically conductive pen body that is generally cylindrical or prismatic in cross section, and a conventional pen cartridge and tip. The soft, electrically conductive tip is electrically conductively connected to the conductive pen body in such a fashion that electrical current and/or charge may be passed freely or with some resistance between the two. Furthermore, when the electrically conductive pen body is electrically connected to an auxiliary conductive or capacitive element, such as the human body or an electrically conductive or capacitive glove, electrical connection and/or capacitive coupling is achieved between the pen body and the auxiliary conductive or capacitive element.

In another embodiment, a multi-function pen input device comprises a conventional pen input device, such as a ball point or felt tip pen, or a pencil lead feeder for writing on paper media, and a second passive touch screen input device for interaction with touch screen electronic devices. The passive touch screen input device is comprised of a soft, electrically conductive tip, suitable for interaction with the touch screen, an electrically conductive pen body that is generally cylindrical or prismatic in cross section, and a conventional pen cartridge and tip. The soft, electrically conductive tip is electrically conductively connected to the conductive pen body in such a fashion that electrical current and/or charge may be passed freely or with some resistance between the two. The electrically conductive pen body affords a capacitance, with respect to a distant ground, of sufficient magnitude to be detectable by a capacitive touch screen device when the electrically conductive tip is brought near to the touch screen or is touched to the touch screen.

In a further embodiment, a multi-function pen input device comprises a conventional pen input device, such as a ball point or felt tip pen, or a pencil lead feeder for writing on paper media, and a second passive touch screen input device for interaction with touch screen electronic devices. The passive touch screen input device is comprised of a soft, electrically conductive tip, suitable for interaction with the touch screen, a non-conductive pen body that is generally cylindrical or prismatic in cross section, an electrically conductive coating applied to the non-conductive pen body, and a conventional pen cartridge and tip. In this embodiment, the electrically conductive tip is in electrically conductive connection with the conductive surface of the non-conductive pen body.

In another embodiment, a multi-function pen input device further includes a second soft electrically conductive stylus that enables the pen input device to be used as a second input device enabling the user to take advantage of multi-touch technologies and applications. In this manner the pen input device and the second soft stylus may be used to enable multi-touch interaction with a multi-touch sensitive touch screen.

In another embodiment, a cam arrangement, or other mechanism, is provided that selectively and alternatively allows the ball point pen and/or pencil lead feeder and/or soft passive stylus to be placed in a use position, for example, by way of a twist of the cap portion with respect to the barrel portion.

In another embodiment, a multi-function pen input device comprises a conventional pen input device, such as a ball point or felt tip pen, or a pencil lead feeder for writing on paper media, and a second passive touch screen input device for interaction with touch screen electronic devices. The passive touch screen input device is comprised of a soft, electrically conductive tip, suitable for interaction with the touch screen, an electrically conductive pen body that is generally cylindrical or prismatic in cross section, and a conventional pen cartridge and tip. The soft, electrically conductive tip is electrically conductively connected to the conductive pen body in such a fashion that electrical current and/or charge may be passed freely or with some resistance between the two. The electrically conductive tip is fashioned in a geometry that affords an angled surface suitable for flat or substantially flat application to touch screen device when used in a conventional writing or interaction orientation.

In another embodiment, a generally cylindrical pen input device comprises a writing end, such as a ball point pen tip or pencil lead feeder tip, and a soft passive stylus input end, located on the opposite end of the generally cylindrical pen input device, and a cap comprising an second passive input device at its tip. Such an input device would enable the user to interact with the touch screen when the cap is affixed to the pen input device by either using the passive input device in the cap or the passive input device on the opposite end of the pen. Further when the cap is removed, the pen input device would enable writing on paper media with the paper input device end while enabling interaction with a touch screen device with the passive input device located on the opposite end from the pen input end.

In another embodiment a multi-function writing apparatus has two complementary bodies which are joined to form a single writing apparatus for use as a ball point pen and non-marking capacitive touch screen stylus. The two complementary bodies are a front section and a rear section. The front section has a chamber for holding one or more ball point pen, ink, or pencil cartridges or a stylus cartridge.

Portions of the cartridges are extendable through an opening in the front section of the writing tip. The back of the front section is open and forms the sleeve for receiving the rear section. The rear section is a non-marking capacitive touch screen stylus, which may be comprised of conductive materials including leather, fabric, foam, rubber, silicone, or a soft flexible conductive material that can be used to interface with a touch screen device via a capacitive coupling. The rear section of the pen can be made in multiple shapes and sizes, depending upon the needs of the user, ranging from a diameter of approximately 3.5 mm to 7 mm.

The description, objects and advantages of the present invention will become apparent from the detailed description to follow, together with the accompanying drawings.

### BRIEF DESCRIPTION OF THE DRAWINGS

FIG. 1 is an illustration of a writing and stylus apparatus in accordance with one embodiment of the present invention.

FIG. 2 is an illustration of a writing and stylus apparatus having an angled end in accordance with another embodiment of the present invention.

FIG. 3 is an illustration of a writing and stylus apparatus having a rotatable section in accordance with another embodiment of the present invention.

FIGS. 4A-4B are illustrations of a writing and stylus apparatus comprising an actuatable stylet in accordance with another embodiment of the present invention.

FIG. 5 is an illustration of a writing and stylus apparatus with a removable cap in accordance with another embodiment of the present invention.

FIG. 6 is an illustration of a writing and stylus apparatus having a shaped pocket clip in accordance with another embodiment of the present invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Also, it is to be appreciated that unless defined otherwise, all technical and scientific terms used herein have the same meaning as commonly understood by one of ordinary skill in the art to which this invention belongs.

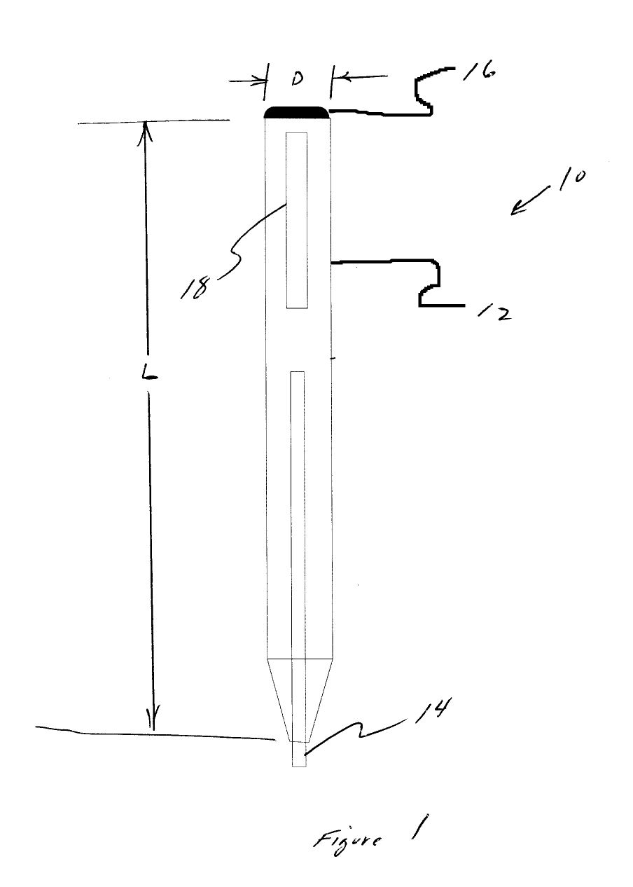

FIG. 1 shows a multi-function writing and stylus apparatus 10 or pen input device in accordance with the present invention. The writing apparatus 10 in FIG. 1 shows an electrically conductive pen body 12, a conventional pen writing input device for paper media 14, and a soft passive stylus input end 16. Pen 10 also includes a pocket clip 18.

The electrically conductive body may vary in its shape. For example, it may have a cylindrical cross section. Additionally, the length (L) of the electrically conductive body is at least 8 cm and more preferably ranges from 11 cm or longer. The body may be made of an electrically conductive material such as aluminum or conductive plastics. In another embodiment, the body comprises a non-conductive material and has an electrically conductive coating or lining (or wire member) to provide a capacitive coupling to the touch screen device.

The pen writing input device may vary widely. Examples include a ball point pen, felt tip pen, and/or a pencil lead feeder.

The shape and size of the stylus input device may vary. Preferably the shape and size of the stylus input device is sufficient to form a capacitive coupling with the touch screen display device. In one embodiment, the diameter of the soft conductive material may range from approximately 1.5 mm to 7 mm. Its thickness preferably ranges from 1 mm to 1 cm.

The stylus input device comprises a soft electrically conductive material. Examples of suitable electrically conductive material include rubber, silicone, foam, fabric, PVC, and leather. In a preferred embodiment the conductive material is comprised of a material having a conductivity equal to or less than about 10⁵ and preferably below 10³ Ohm/cm². In another embodiment the conductive material is comprised of a material having a density between 0.5-3.1 lbs/ft³.

It is also preferred that the conductive material is not abrasive. The conductive material is preferably soft or smooth such that it does not scratch the surface of the touch screen display when it is in contact with the touch screen display. Examples include, without limitation, leather (product number TTG-A-B manufactured by Broleco, Inc. Lawrence, Mass.) and CFME2436-18 manufactured by Conductive Containers, Inc. U.S. Patent Application Nos. 61/217,653, filed Jun. 4, 2009, 61/240,934, filed Sep. 9, 2009, 61/266,840, filed Dec. 4, 2009, and 61/285,468, filed Dec. 10, 2009, PCT/2010/037286, filed Jun. 3, 2010, all to J. Leto describe an exemplary leather that may be used as a conductive material in accordance with the present invention and is incorporated herein by reference in its entirety.

The conductive material of the stylus may be affixed to the end of the writing apparatus by a conductive adhesive bond of, for example, a conductive epoxy or another conductive bonding resin, or may be adhered without a conductive adhesive provided that the majority of the surface area of the conductive material is in direct contact with the conductive body of the pen or a holder inserted or part of the pen, respectively.

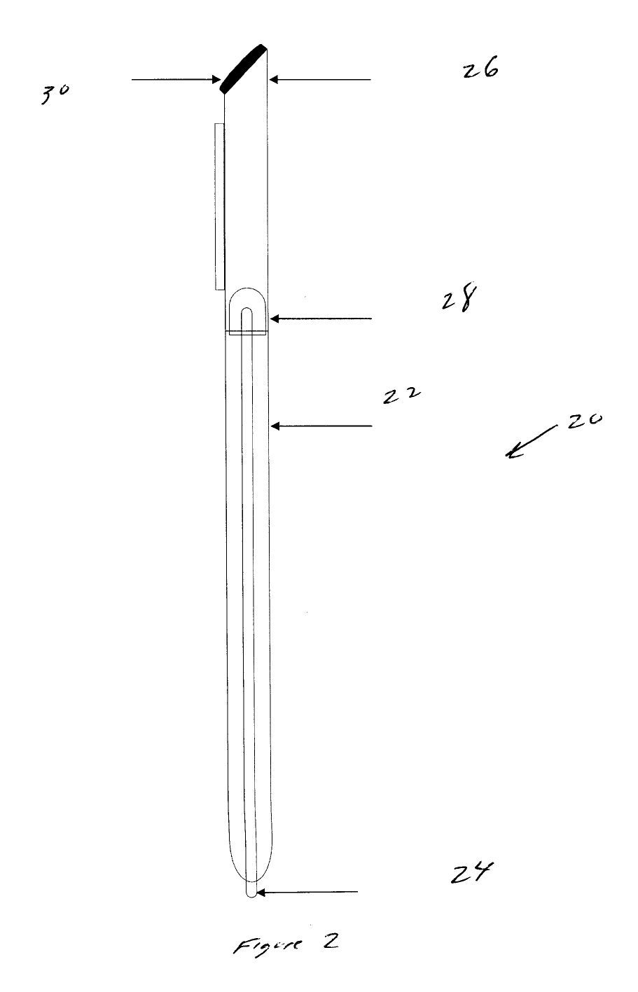

FIG. 2 shows another multi-function writing apparatus or pen input device 20. The pen 20 shown in FIG. 2 includes an electrically conductive pen body 22, a conventional pen writing input device for paper media 24, soft passive stylus input end 26, and an electrically conductive plastic ink cartridge holder 28, and an angled top to the pen 30.

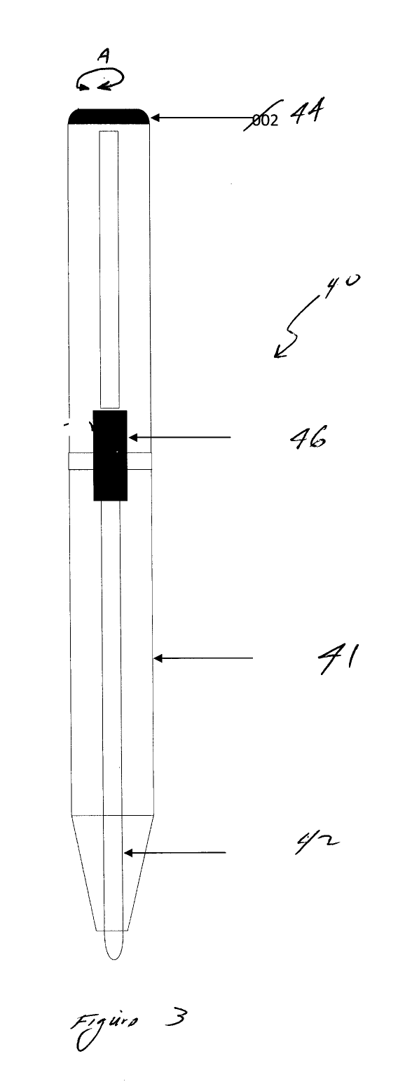

FIG. 3 shows another multi-function writing apparatus or pen input device 40. The pen 40 shown in FIG. 3 includes an electrically conductive pen body 41, a conventional pen writing input device for paper media 42, soft passive stylus input end 44, and an electrically conductive plastic ink cartridge holder 46. As shown, the body 40 comprises a first portion that is rotatable relative to a second portion of the body. Rotation of the first portion to the second portion serves to eject a tip of the writing device 42 from the second end of the body.

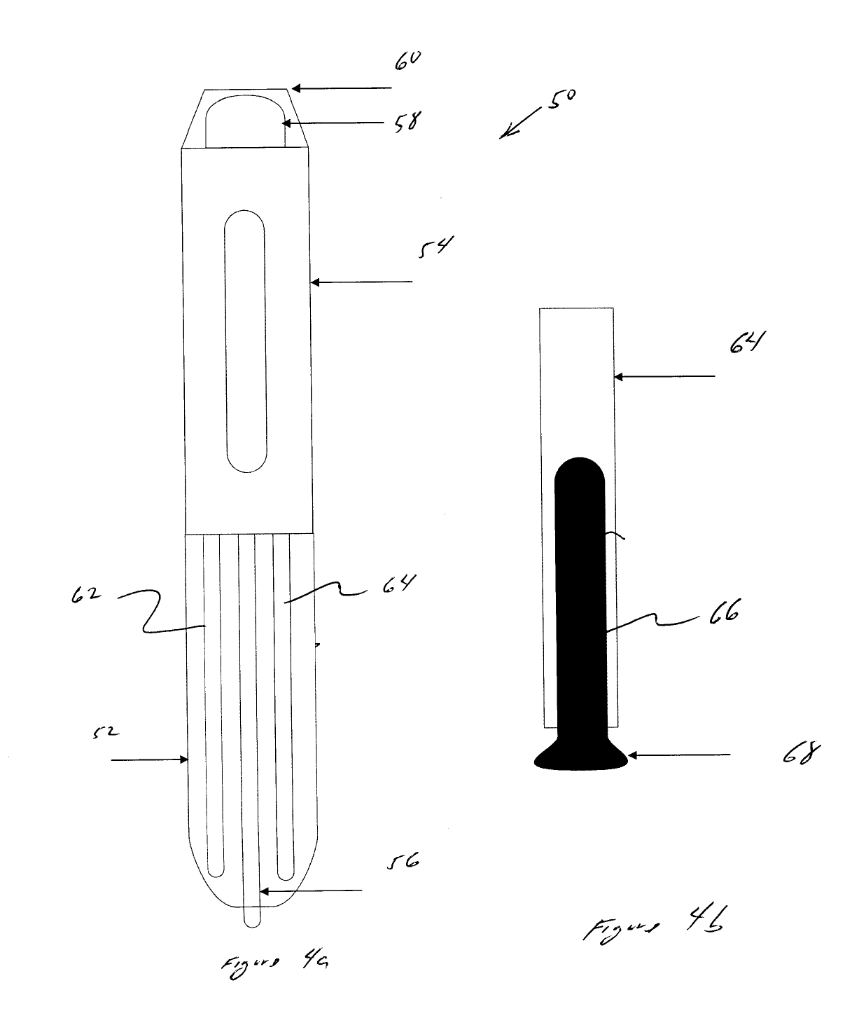

FIG. 4A shows another embodiment of a multi-function writing apparatus or pen input device 50. The pen shown in FIG. 4A includes an electrically conductive lower pen body 52, an electrically conductive upper pen body 54, a conventional pen writing input device for paper media 56, a pencil eraser 58, a threaded eraser cap cover 60, a mechanical pencil paper media input device 62, a foam stylus tube 64, and a conductive foam element 66.

The lower pen body or first portion of the body is rotatable with the second portion of the body. The lower pen body comprises a cavity for holding a plurality of tools including for example the stylus tube and a writing device 62. The stylet conductive material 66 is adapted to capacitively couple with a touch screen display. An example of a suitable foam is Corestat CFME2436.

Conductive foam element 66 is shown in an extended position having an enlarged or flared end 68. The enlarged end serves to make greater contact area with a touch screen display (not shown). It is to be understood the end 68 may have a wide variety of shapes with a preferably surface contact area of about 4-6 sq. mm. and most preferably about 5 sq. mm. A preferred surface area of the electrically conductive portion to contact the touch screen is about that of an adult finger tip.

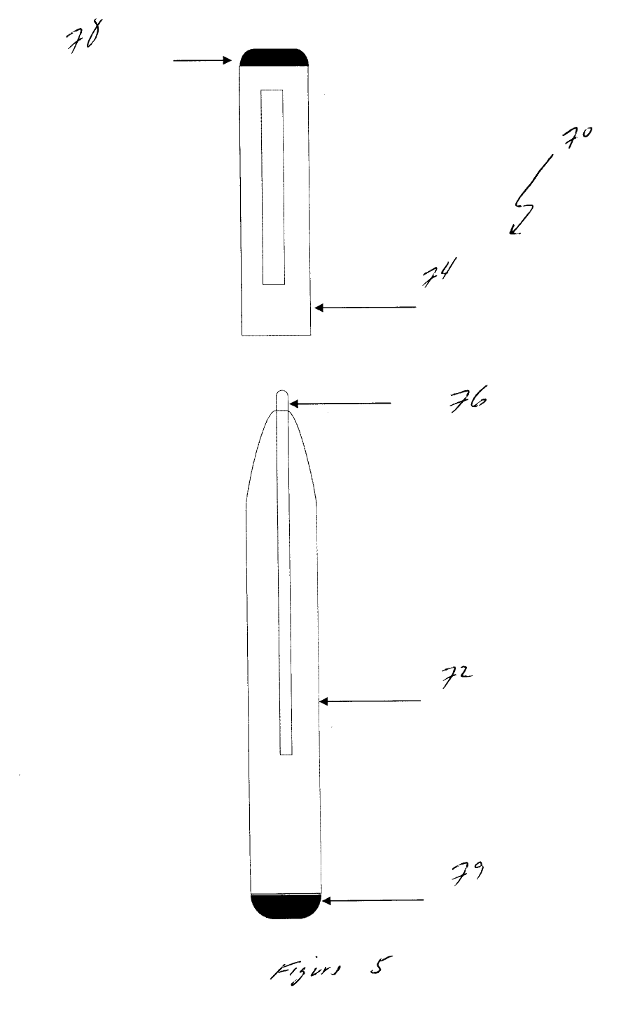

FIG. 5 shows another multi-function writing apparatus or pen input device 70. The pen 70 shown in FIG. 5 includes an electrically conductive pen body 72, an electrically conductive cap 74, a conventional pen writing input device for paper media 76, and two soft passive stylus input ends 78, 79. In operation, cap 74 is affixed to pen body 72 and either of the stylus input ends are urged against a touch screen display to carry out a multi-touch function or gesture including, for example, scroll down, rotation, or enlargement/zoom.

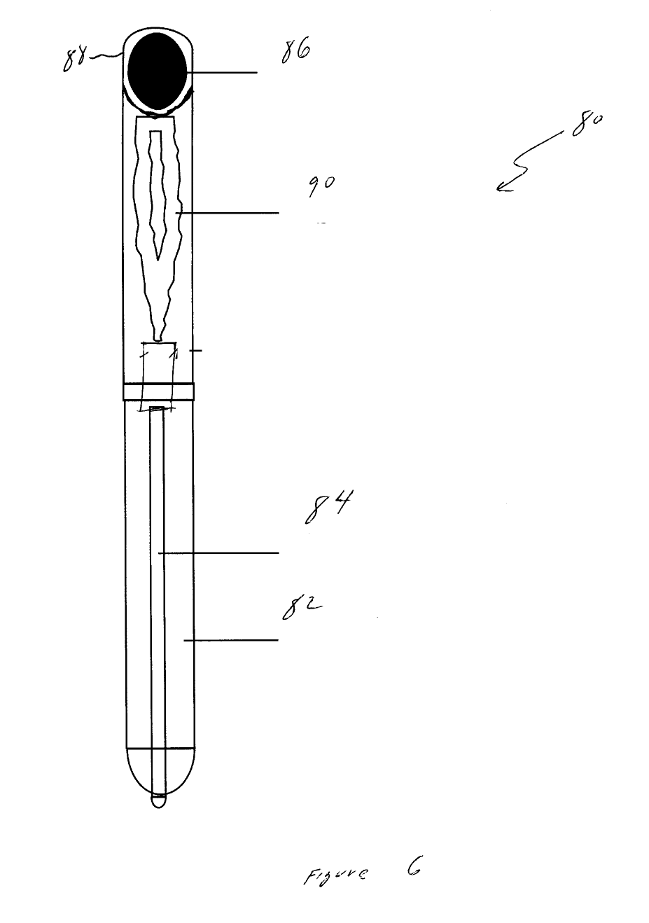

FIG. 6 shows another multi-function writing apparatus or pen input device 80. The pen includes an electrically conductive pen body 82, a pressurized media cartridge writing input device 84 adapted to write under any condition, for instance, write at any angle (including upside down), write under extreme conditions (freezing cold and extreme heat) and on any surface. Such a cartridge may be made of a robust vessel material such as, for example, steel and loading the vessel with an ink at a relatively high pressure.

The pen shown in FIG. 6 also includes a soft passive stylus input end 86, an angled top to the pen 88, and an icicle shaped pocket clip 90.

Other modifications and variations can be made to the above disclosed embodiments without departing from the subject invention. For example, the apparatus may be combined in a system and include the multifunction writing apparatus and touch screen display computing device or PDA. Additionally, the components of the apparatus may be stand alone devices such as, for example, the cap comprising an electrically conductive material. Thus, while the exemplary embodiments have been described in detail, by way of example and for clarity of understanding, a variety of changes, adaptations, and modifications will be obvious to those of skill in the art. Therefore, the scope of the present invention is limited solely by the appended claims.

1. A writing device and stylus combination apparatus comprising: a body, the body comprising a first end and a second end; the first end comprising a conductive material and the second end comprising a writing device and wherein the conductive material forms an enlarged or flared end for making limited contact with a touch screen display and wherein the limited contact comprises a surface contact area of ranging from 4-6 mm².

2. The apparatus of claim 1, wherein the writing device comprises a media ink cartridge.

3. The apparatus of claim 2, wherein the ink cartridge is adapted to write on a plurality of surfaces, to write upside down, or to write between temperatures of −45° C., to +200° C.

4. The apparatus of claim 1, wherein the conductive material is comprised of one material selected from the group consisting of rubber, silicone, foam, fabric, PVC, and leather.

5. The apparatus of claim 1, wherein the conductive material is comprised of a material having a conductivity of below 10⁵ Ohm/cm².

6. The apparatus of claim 1, wherein the conductive material is comprised of a material having a density between 0.5 and 3.1 lbs/ft³.

7. The apparatus of claim 1, wherein the conductive material is comprised of a material having the property of not scratching a surface of a touch screen display when it is contact with the touch screen display.

8. The apparatus of claim 1, wherein the apparatus is adapted to allow a user to control a touch screen device with the first end, and write on a paper medium with the second end.

9. The apparatus of claim 1, wherein said first end is adapted to control a capacitive touch screen device when the conductive material of the first end is touched to the screen of the touch screen device and second end is adapted to write on a paper medium.

10. The apparatus of claim 1, wherein the conductive material of the first end comprises an angled tip, thereby allowing a user to control a capacitive touch screen device with the apparatus contacting the touch screen device at an angle less than 90 degrees.

11. A multifunctional writing apparatus comprising: a body comprising a first end and a second end, and the first end comprising a writing member; and a removable cap enclosing the first end, and wherein the cap comprises a tip, and a conductive material disposed on the tip for interfacing with a capacitive based touch screen.

12. The apparatus of claim 11, wherein the cap mechanically attaches on the first end and the second end of the apparatus.

13. The apparatus of claim 12 wherein the second end comprises a conductive material and wherein the apparatus is adapted to allow user to remove the cap and use the cap and the second end of the body simultaneously to control gesture capabilities of a multi-touch touch screen display device.

14. The apparatus of claim 1, wherein the second end comprises at least one of a mechanical lead pencil, a ball point pen, or a writing device.

15. The apparatus of claim 1, wherein the conductive material is affixed to the first end of the apparatus by a conductive adhesive bond.

16. The apparatus of claim 15 wherein said adhesive bond is formed from one of the adhesives selected from the group consisting of a conductive epoxy or a conductive bonding resin.

17. The apparatus of claim 1, wherein the body is comprised of a conductive material, or comprises a conductive coating on the outer surface of a non-conductive material to provide capacitive coupling to the touch screen device.

18. The apparatus of claim 1 wherein the body comprises a first portion that is rotatable relative to a second portion of the body, whereby rotation of the first portion to the second portion serves to eject a tip of the writing device from the second end of the body.

19. A writing device and stylus combination apparatus comprising: a body, the body comprising a first portion and second portion rotatable to the first portion; the first portion comprising a cavity for holding at least a stylet and a writing device wherein said stylet comprises a conductive material adapted to capacitively couple with a touch screen display.

20. (canceled)
